(19) United States
(12) Patent Application Publication
(10) Pub. No.: US 2011/0280651 A1
(43) Pub. Date: Nov. 17, 2011

(54) Connecting device to prevent worker from falling

(75) Inventor: Hsien Yaq Chiang, Changhua (TW)

(73) Assignee: Aerohook Technology Co., Ltd.

(21) Appl. No.: 12/800,269

(22) Filed: May 12, 2010

(51) Int. Cl. F16B 7/04

(52) U.S. Cl. 403/322.4

(57) ABSTRACT

A connecting device for attaching to a rail of a scaffolding includes a barrel attached to a lever for coupling to a worker, two gripping members slidably attached onto the lever for adjustably engaging with the rails of different width, and one or more fasteners slidably attached to the lever for selectively engaging with the gripping members and for anchoring and securing the gripping members to the lever at the selected position, and for safely anchoring and retaining the worker on the scaffolding and for preventing the worker from falling from the scaffolding inadvertently.

### BACKGROUND OF THE INVENTION

1. Field of the Invention

The present invention relates to a rail hooking or connecting device, and more particularly to a hooking or connecting device including an adjusting structure for adjustably attaching or mounting onto various rails of different width or structure of a scaffolding and for safely anchoring and retaining the worker on the scaffolding and for preventing the worker from falling from the scaffolding inadvertently.

2. Description of the Prior Art

Various kinds of typical rail hooking or connecting members have been provided and developed for being attached to the conventional scaffolding and coupled to the worker, and for safely anchoring and retaining or connecting the worker to the scaffolding and for preventing the worker from falling from the scaffolding inadvertently while the worker is working on the scaffolding, normally, the typical connecting devices or assemblies comprise one or more collars for slidably attaching or mounting onto the tubular posts or the tubular rails of the scaffolding for slidably connecting the worker to the scaffolding.

For example, U.S. Pat. No. 5,361,866 to Bell et al. discloses one of the typical connecting devices or assemblies for use on scaffolding in order to prevent the worker from falling from the scaffolding inadvertently.

However, the tubular posts and/or the tubular rails of the scaffolding may include different widths or shapes or structures or diameters, and the collars of the typical connecting devices or assemblies may not be changed or adjusted to different widths or shapes or structures or diameters in order to suitably fit or attach or secure onto the tubular posts and/or the tubular rails of the conventional scaffolding that includes different widths or shapes or structures or diameters.

The present invention has arisen to mitigate and/or obviate the afore-described disadvantages of the conventional connecting devices for use on scaffoldings.

### SUMMARY OF THE INVENTION

The primary objective of the present invention is to provide a connecting device including an adjusting structure for adjustably attaching or mounting onto various rails of different width or structure of a scaffolding and for safely anchoring and retaining the worker on the scaffolding and for preventing the worker from falling from the scaffolding inadvertently.

In accordance with one aspect of the invention, there is provided a connecting device for attaching to a rail of a scaffolding comprising a lever including a non-circular cross section having at least three planar surfaces formed on an outer peripheral portion thereof, and having an outer thread formed on the outer peripheral portion thereof, the lever including two end portions, a barrel attached to the lever for coupling to a worker, two gripping members each including a non-circular orifice formed therein for slidably engaging with the lever and for slidably attaching the gripping members onto the lever and for adjustably attaching and mounting the gripping members and the lever to the rail, and for preventing the gripping members from rotating relative to the lever, and at least one fastener slidably attached to the lever for selectively engaging with the gripping members and for anchoring and securing the gripping members to the lever at a selected position.

The barrel includes a first end portion and a second end portion, and includes a tapered peripheral surface formed in the second end portion thereof, and a collar attached onto the second end portion of the barrel and engaged with the tapered peripheral surface of the barrel for forcing and clamping the second end portion of the barrel onto the lever.

The barrel includes at least one slit formed in the second end portion thereof for allowing the second end portion of the barrel to be selectively narrowed and to engage with the lever. The barrel includes a peripheral flange extended radially and outwardly from the first end portion of the barrel and having an outer diameter greater than that of the barrel.

The level includes a limiting member attached to either of the end portions of the lever and having an outer diameter greater than that of the lever for preventing the gripping members and the fastener from being disengaged form the lever inadvertently.

The fastener is an adjusting fastener, and at least one locking fastener is attached to the lever and engageable with the fastener for anchoring and positioning the fastener and the gripping members on the lever.

The gripping members each include a reinforcing protrusion extended outwardly therefrom and having the orifice formed in the reinforcing protrusion for reinforcing the gripping members. The gripping members each include a finger member extended therefrom, and each include a spring-biased projection attached to the finger member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial side plan schematic view illustrating the operation of a connecting device in accordance with the present invention for use on a scaffolding;

FIG. 2 is a perspective view of the connecting device for use on the scaffolding;

FIG. 3 is a partial exploded view of the connecting device for use on the scaffolding;

FIG. 4 is a side plan schematic view of the connecting device for use on the scaffolding;

FIG. 5 is a side plan schematic view similar to FIG. 4; illustrating the operation of the connecting device;

FIG. 6 is an enlarged partial side plan schematic view of the connecting device in which a portion of the connecting device has been cut off for showing the inner structure of the connecting device;

FIG. 7 is a perspective view illustrating the other arrangement of the connecting device; and

FIG. 8 is a side plan schematic view of the connecting device as shown in FIG. 7.

### DETAILED DESCRIPTION OF THE PREFERRED EMBODIMENT

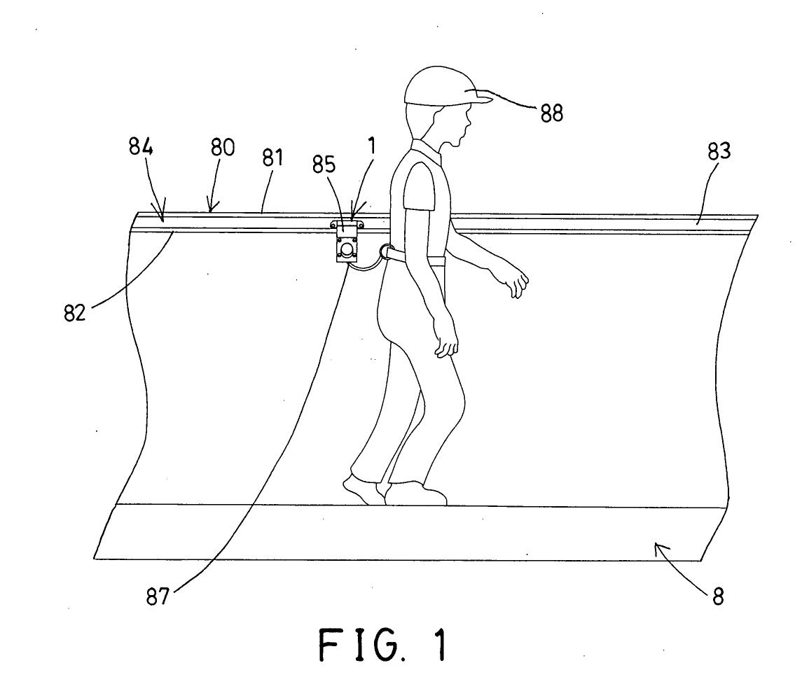

Referring to the drawings, and initially to FIG. 1, a rail hooking or connecting device 1 in accordance with the present invention is provided for being engaged with or attached to the conventional scaffolding 8, such as engaged with or attached to the tracks or rails 80 of the conventional scaffolding 8 and coupled to the worker 88 with such as coupling wires or cables 87 for safely anchoring and retaining or connecting the worker 88 to the scaffolding 8 and for preventing the worker 88 from falling from the scaffolding 8 while the worker 88 is working on the scaffolding 8, the tracks or rails 80 of the conventional scaffolding 8 may include an I-shaped structure having an upper bar 81, a lower bar 82 and an intermediate or vertical bar 83 coupled between the upper bar 81 and the lower bar 82 for forming or defining two side openings or spaces 84 in the rail 80 or between the bars 81, 82.

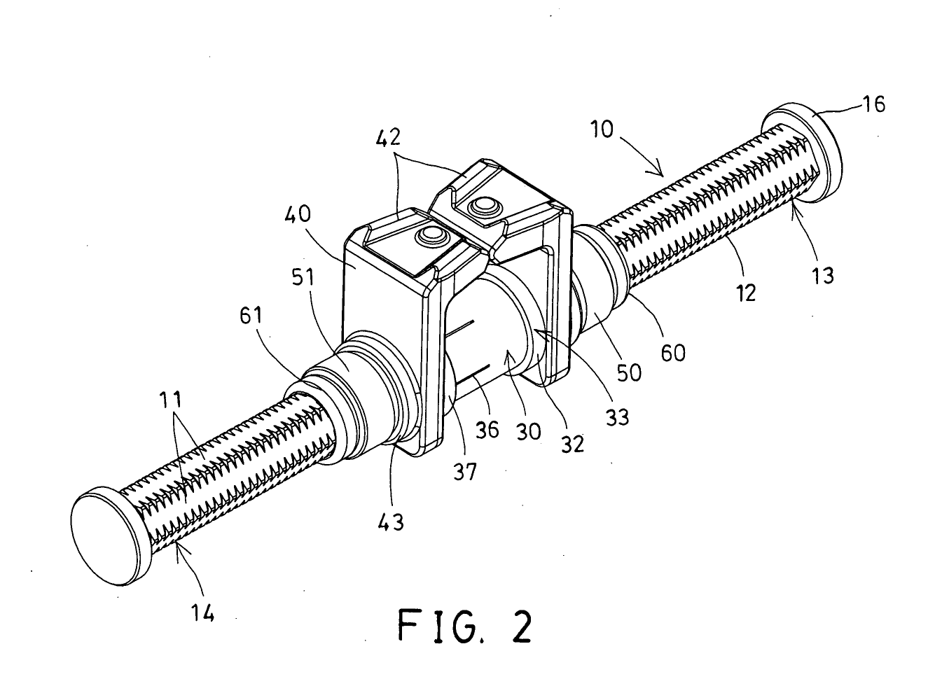

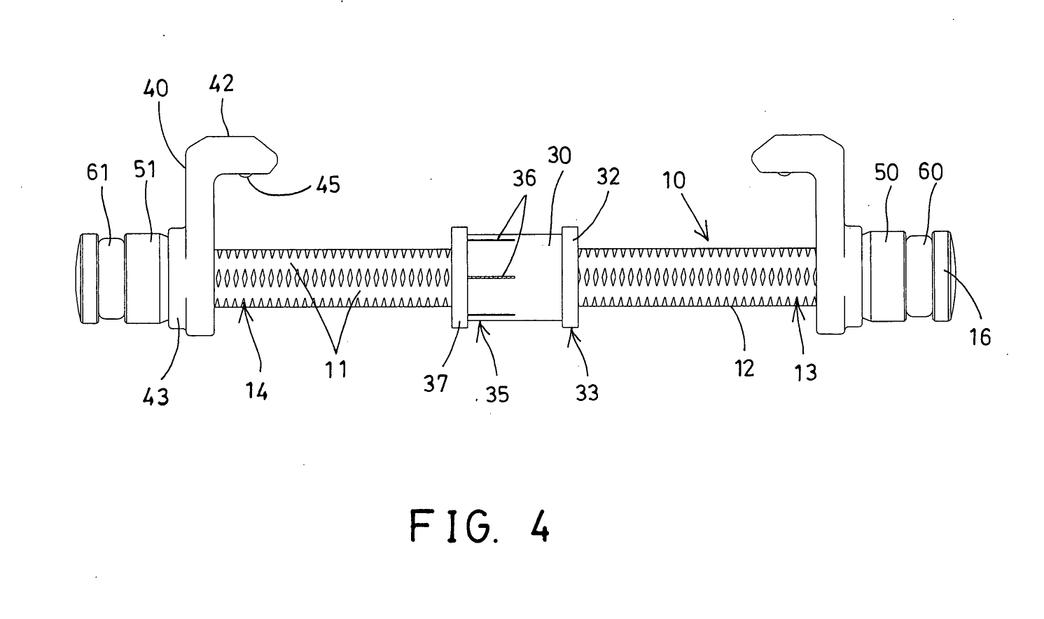

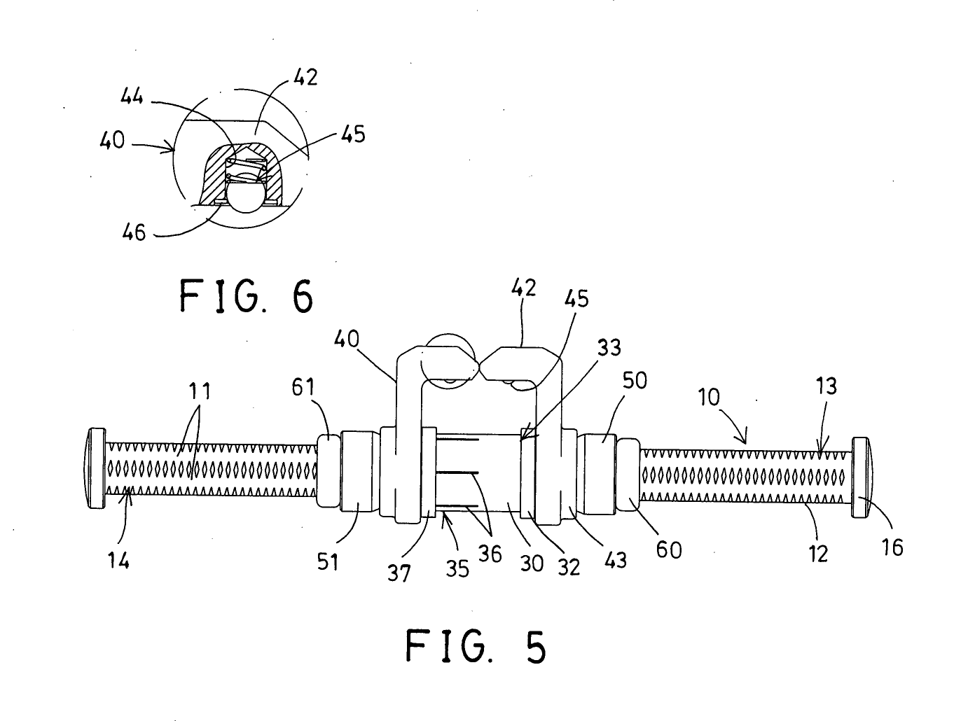

As shown in FIGS. 2-4, the connecting device 1 comprises an elongate or longitudinal rod or lever 10 including a non-circular cross section, such as a hexagonal cross section having one or more (such as six) planar surfaces 11 formed or provided on the outer peripheral portion thereof, and including an outer thread 12 formed on the outer peripheral portion thereof, and including two end portions 13, 14 each having a screw hole 15 formed therein for threading or attaching or engaging with an anchor or stop or limiting member 16 which includes an outer diameter greater than that of the lever 10 for preventing the members or elements from being disengaged form the lever 10 inadvertently.

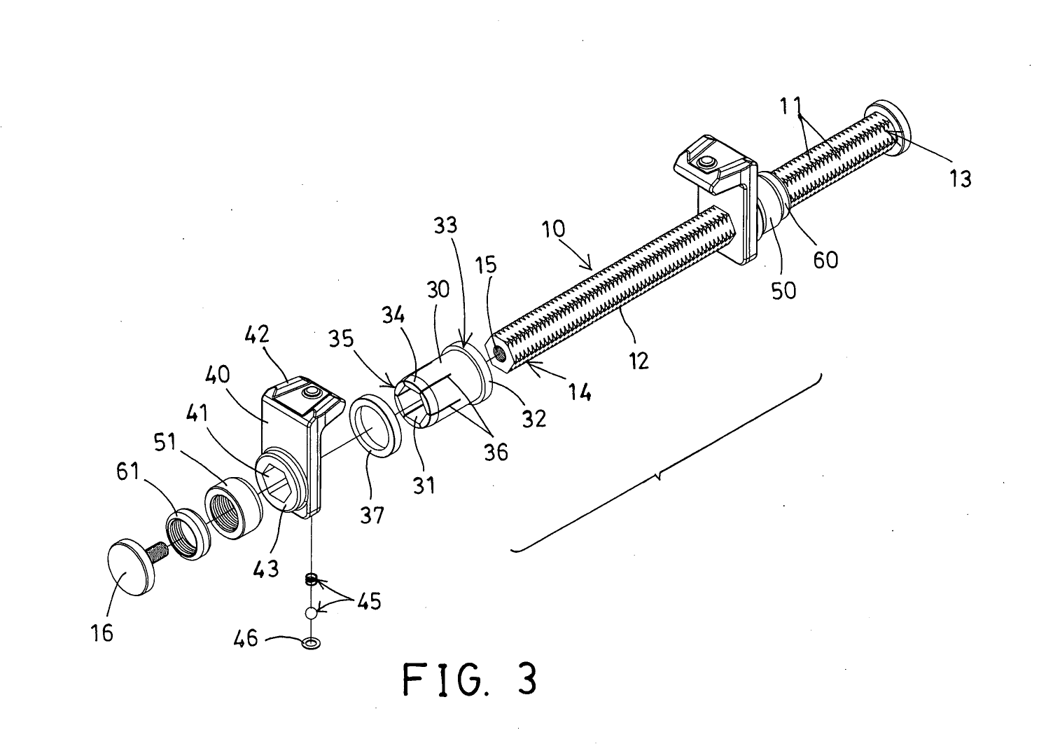

A pulley or seat or barrel 30 includes a non-circular bore 31 formed therein and having a non-circular cross section, such as a hexagonal cross section for slidably receiving or engaging with the lever 10 and for slidably attaching or mounting the barrel 30 onto the lever 10 for guiding the barrel 30 to suitably slide or move along the lever 10 and for preventing the barrel 30 from rotating relative to the lever 10. The barrel 30 includes a peripheral flange 32 extended radially and outwardly therefrom, such as extended from one end portion 33 thereof and having an outer diameter greater than that of the barrel 30, and includes a rounded or inclined or tapered peripheral surface 34 formed in the other end portion 35 thereof (FIG. 3).

The barrel 30 further includes one or more slits 36 formed in the other end portion 35 thereof and intersecting or communicative with the bore 31 of the barrel 30 for increasing the resilience or the flexibility of the other end portion 35 of the barrel 30 and for allowing the other end portion 35 of the barrel 30 to be selectively expanded or narrowed, particularly narrowed in diameter to solidly engage with the lever 10 and to be solidly or firmly attached or mounted or anchored or secured or positioned to the lever 10. A collar 37 may further be provided and attached or engaged onto or with the other end portion 35 of the barrel 30, or engaged with the tapered peripheral surface 34 of the barrel 30 for suitably forcing or clamping the other end portion 35 of the barrel 30 onto the lever 10, and thus for solidly or firmly clamping or securing the barrel 30 onto the lever 10 and for preventing the barrel 30 from slipping along or relative to the lever 10.

In operation, an attachment strap or member 85 (FIG. 1) may further be provided for attaching or mounting onto the barrel 30 or the lever 10, and for being anchored or positioned or retained between the peripheral flange 32 of the barrel 30 and the collar 37, and the attachment strap or member 85 may be attached or mounted or secured or hooked or coupled to the worker 88 with the coupling wires or cables 87 (FIG. 1) for safely anchoring and retaining or securing or connecting the worker 88 to the rail 80 of the scaffolding 8 and for preventing the worker 88 from falling from the scaffolding 8 inadvertently while the worker 88 is working on the scaffolding 8. The limiting members 16 are contactable or engageable with the barrel 30 and may limit the barrel 30 to slide or move along or relative to the lever 10 and may prevent the barrel 30 from being disengaged form the lever 10.

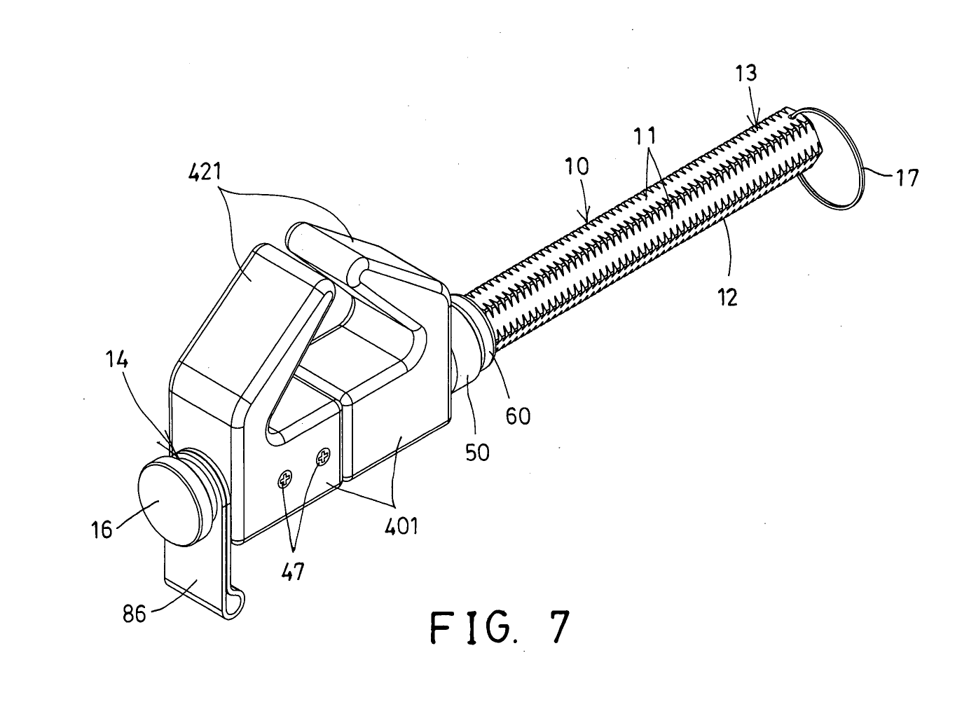

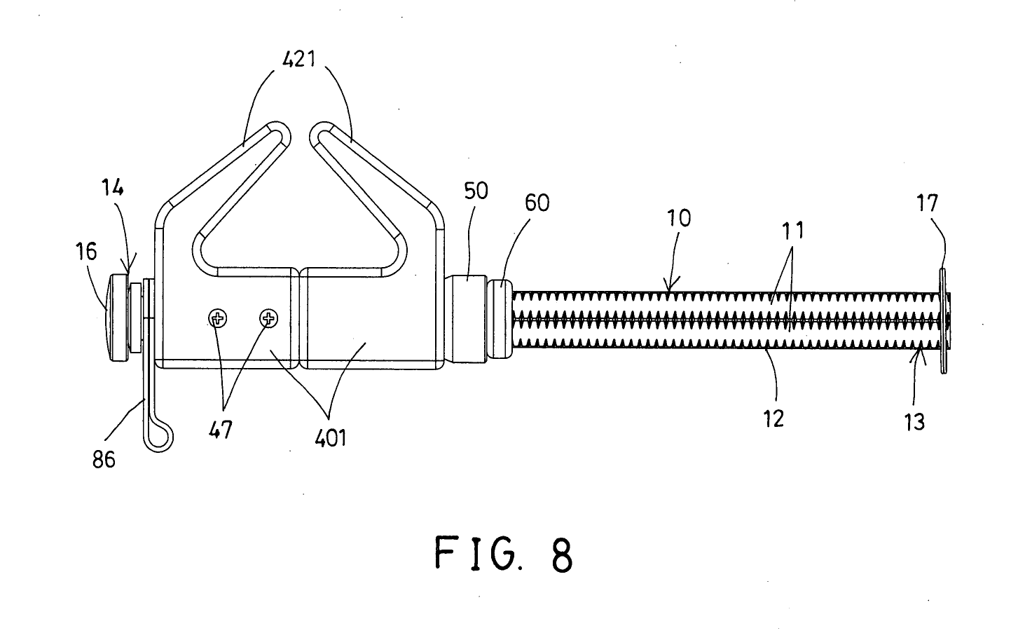

Two pawls or gripping members 40 each include a non-circular orifice 41 formed therein (FIG. 3) for slidably receiving or engaging with the lever 10 and for slidably attaching or mounting the gripping members 40 onto the lever 10 and for preventing the gripping members 40 from rotating relative to the lever 10, and each include a finger member 42 laterally extended therefrom for engaging with or into the spaces 84, 85 of the rail 80 and for gripping or hooking or attaching or mounting or securing the gripping members 40 and the lever 10 to the rail 80 and thus for coupling or connecting the worker 88 to the rail 80 of the scaffolding 8. It is preferable, but not necessarily that the finger member 42 is perpendicular to the gripping member 40, and the gripping member 40 may be directly and slidably attached or mounted onto the lever 10 without the barrel 30. For example, as shown in FIGS. 7 and 8, the finger member 421 may be inclined or tilted relative to the gripping member 401, instead of perpendicular to the gripping member.

The gripping members 40 may be contacted or engaged with the peripheral flange 32 of the barrel 30 and the collar 37 which may anchor and position or secure the gripping members 40 to the lever 10, one of the gripping members 40 may force or move the collar 37 onto the other end portion 35 of the barrel 30, for suitably forcing or clamping the other end portion 35 of the barrel 30 onto the lever 10, and thus for solidly or firmly clamping or securing the barrel 30 onto the lever 10 and thus for preventing the barrel 30 from slipping along or relative to the lever 10. It is preferable, but not necessarily that the gripping members 40 each include an enlarged or thickened or reinforcing protrusion 43 extended outwardly therefrom and having the orifice 41 formed in the reinforcing protrusion 43 for suitably reinforcing the gripping members 40.

It is preferable that the gripping members 40 each include a cavity 44 formed in the finger member 42 (FIG. 6) for receiving or engaging with a spring-biased projection 45, and a clamping or retaining ring 46 may further be provided and attached or mounted or secured to the finger member 42 and engaged with the spring-biased projection 45 for suitably or stably or solidly anchoring or positioning and securing the spring-biased projection 45 within the cavity 44 of the finger member 42 and for preventing the spring-biased projection 45 from being disengaged form the finger member 42 of the gripping members 40. The spring-biased projection 45 is partially extended out of the finger member 42 for engaging with the lower bar 82 of the rail 80.

Two or two pairs of lock nuts or fasteners, such as two adjusting fasteners 50, 51 and two locking fasteners 60, 61 are threaded or attached or mounted or secured to or engaged with the lever 10 and contactable or engageable with the gripping members 40 for suitably or stably or solidly anchoring or positioning and securing the gripping members 40 on the lever 10 at the required or selected position or location. For example, the adjusting fasteners 50, 51 may be engaged with the gripping members 40 for forcing or clamping the gripping members 40 onto the rail 80, and the locking fasteners 60, 61 may be engaged with the adjusting fasteners 50, 51 respectively for locking the adjusting fasteners 50, 51 and the gripping members 40 onto the rail 80. The limiting members 16 are also contactable or engageable with the locking fasteners 60, 61 and may prevent the fasteners 50, 51; 60, 61 from being disengaged form the lever 10.

Alternatively, as shown in FIGS. 7 and 8, the gripping member 401 may also be attached or mounted or secured to one of the two end portions 14 of the lever 10 with latches or fasteners 47, and/or with the fasteners 50, 60, and another attachment strap or member 86 may further be provided and attached or mounted or secured onto the end portion 14 of the lever 10 with the gripping member 401 and the limiting member 16, and/or for being anchored or positioned or retained between the gripping member 401 and the limiting member 16, and the attachment strap or member 86 may be attached or mounted or secured or hooked or coupled to the worker 88 with the coupling wires or cables 87 (FIG. 1) for safely anchoring and retaining or securing or connecting the worker 88 to the rail 80 of the scaffolding 8 and for preventing the worker 88 from falling from the scaffolding 8 inadvertently while the worker 88 is working on the scaffolding 8. A coupling ring 17 may be attached or mounted or secured onto the end portion 13 of the lever 10 for coupling to various objects (not shown).

Accordingly, the connecting device in accordance with the present invention includes an adjustable structure for adjustably attaching or mounting onto various rails of different width or structure of the scaffolding and for safely anchoring and retaining the worker on the scaffolding and for preventing the worker from falling from the scaffolding inadvertently.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A connecting device for attaching to a rail of a scaffolding comprising:
a lever including a non-circular cross section having at least three planar surfaces formed on an outer peripheral portion thereof, and having an outer thread formed on the outer peripheral portion thereof, said lever including two end portions,
a barrel attached to said lever for coupling to a worker,
two gripping members each including a non-circular orifice formed therein for slidably engaging with said lever and for slidably attaching said gripping members onto said lever and for adjustably attaching and mounting said gripping members and said lever to the rail, and for preventing said gripping members from rotating relative to said lever, and
at least one fastener slidably attached to said lever for selectively engaging with said gripping members and for anchoring and securing said gripping members to said lever at a selected position.

2. The connecting device as claimed in claim 1, wherein said barrel includes a first end portion and a second end portion, and includes a tapered peripheral surface formed in said second end portion thereof, and a collar attached onto said second end portion of said barrel and engaged with said tapered peripheral surface of said barrel for forcing and clamping said second end portion of said barrel onto said lever.

3. The connecting device as claimed in claim 2, wherein said barrel includes at least one slit formed in said second end portion thereof for allowing said second end portion of said barrel to be selectively narrowed and to engage with said lever.

4. The connecting device as claimed in claim 2, wherein said barrel includes a peripheral flange extended radially and outwardly from said first end portion of said barrel and having an outer diameter greater than that of said barrel.

5. The connecting device as claimed in claim 1, wherein said level includes a limiting member attached to either of said end portions of said lever and having an outer diameter greater than that of said lever for preventing said gripping members and said at least one fastener from being disengaged form said lever inadvertently.

6. The connecting device as claimed in claim 1, wherein said at least one fastener is an adjusting fastener, and at least one locking fastener is attached to said lever and engageable with said at least one fastener for anchoring and positioning said at least one fastener and said gripping members on said lever.

7. The connecting device as claimed in claim 1, wherein said gripping members each include a reinforcing protrusion extended outwardly therefrom and having said orifice formed in said reinforcing protrusion for reinforcing said gripping members.

8. The connecting device as claimed in claim 1, wherein said gripping members each include a finger member extended therefrom, and each include a spring-biased projection attached to said finger member.
